(19) United States
(12) Patent Application Publication
(10) Pub. No.: US 2025/0013559 A1
(43) Pub. Date: Jan. 9, 2025

(54) METHOD FOR GENERATING TEST CASES

(71) Applicant: BEIJING BAIDU NETCOM SCIENCE TECHNOLOGY CO., LTD., Beijing (CN)

(72) Inventor: Jiacheng Jiao, Beijing (CN)

(73) Assignee: BEIJING BAIDU NETCOM SCIENCE TECHNOLOGY CO., LTD., Beijing (CN)

(21) Appl. No.: 18/745,747

(22) Filed: Jun. 17, 2024

(30) Foreign Application Priority Data
Feb. 29, 2024 (CN) 202410233321.X

(51) Int. Cl. G06F 11/36

(52) U.S. Cl. CPC G06F 11/3684

(57) ABSTRACT

The disclosure discloses a method for generating test cases, an apparatus for generating test cases, an electronic device and a storage medium, and relates to a field of computer technology, in particular to a field of artificial intelligence such as a large model and natural language processing. The method includes: obtaining an original statement of work (SOW) of a target project and product information of a software product to be tested associated with the target project; obtaining product documentation and target historical test cases of the software product to be tested according to the product information; segmenting the original SOW and obtaining a plurality of segmented SOWs; and generating target test cases of the software product to be tested according to the plurality of segmented SOWs, the product documentation and the target historical test cases.

### CROSS-REFERENCE TO RELATED APPLICATION

This application claims the priority to Chinese Patent Application No. 202410233321.X, filed on Feb. 29, 2024, the entire contents of which are incorporated herein by reference in their entireties.

### TECHNICAL FIELD

The disclosure relates to a field of computer technology, especially to a field of artificial intelligence (AI) such as a large model and natural language processing, and more particular to method for generating test cases and an electronic device.

### BACKGROUND

A test case is a description of a test task for a software product, which includes a test scheme, a method, a technique and a strategy. The contents of the test case include a test objective, a test environment, an input data, test steps, expected results, test scripts, etc.

For example, in a project delivery process, quality assurance is an important part of project delivery, and test cases are used as important means of quality assurance.

### SUMMARY

According to a first aspect of the disclosure, a method for generating test cases is provided. The method includes:
obtaining an original statement of work (SOW) of a target project and product information of a software product to be tested associated with the target project;
obtaining product documentation and target historical test cases of the software product to be tested according to the product information;
segmenting the original SOW and obtaining a plurality of segmented SOWs; and
generating a target test case of the software product to be tested according to the plurality of segmented SOWs, the product documentation and the target historical test cases.

According to a second aspect of the disclosure, an electronic device for generating test cases is provided. The electronic device includes:
at least one processor; and
a memory communicatively connected to the at least one processor;
in which the memory stores instructions executable by the at least one processor, and the at least one processor is caused to implement the method described in the above embodiments.

### BRIEF DESCRIPTION OF THE DRAWINGS

The accompanying drawings are used to better understand this solution and do not constitute a limitation to the disclosure.

FIG. 1 is a flowchart of a method for generating test cases according to an embodiment of the disclosure.

FIG. 2 is a schematic diagram of a process of converting an image according to a textual description of an embodiment of the disclosure.

FIG. 3 is a flowchart of a method for generating test cases according to an embodiment of the disclosure.

FIG. 4 is a flowchart of a method for generating test cases according to an embodiment of the disclosure.

FIG. 5 is an example diagram of a knowledge graph according to an embodiment of the disclosure.

FIG. 6 is a flowchart of a process of knowledge fusion according to an embodiment of the disclosure.

FIG. 7 is a flowchart of a method for generating test cases according to an embodiment of the disclosure.

FIG. 8 is a block diagram of an apparatus for generating test cases according to an embodiment of the disclosure.

FIG. 9 is a block diagram of an electronic device for implementing the method for generating test cases according to an embodiment of the disclosure.

### DETAILED DESCRIPTION

The following description of exemplary embodiments of the disclosure is provided in combination with the accompanying drawings, which includes various details of the embodiments of the disclosure to aid in understanding and should be considered merely exemplary. Those skilled in the art understood that various changes and modifications of the embodiments described herein can be made without departing from the scope and spirit of the disclosure. For the sake of clarity and brevity, descriptions of well-known functions and structures are omitted from the following description.

A method for generating test cases, an apparatus for generating test cases, an electronic device and a storage medium of the embodiments of the disclosure are described below with reference to the accompanying drawings.

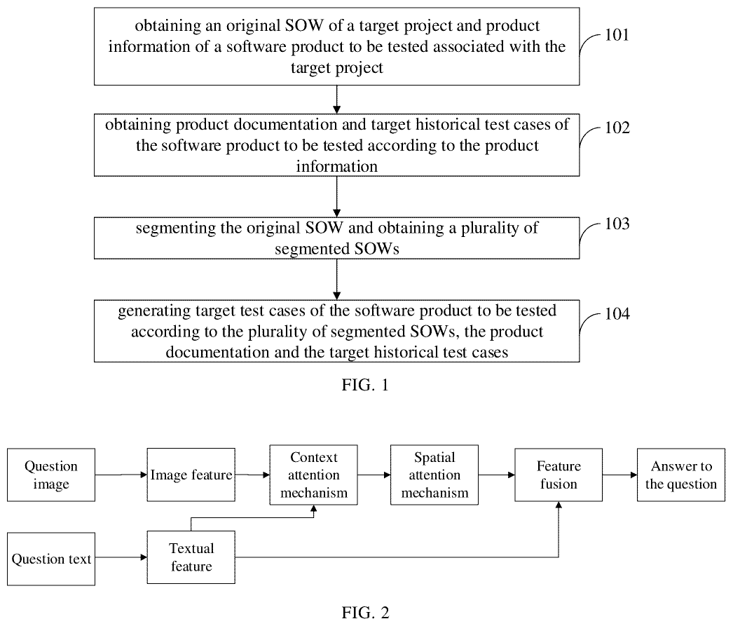

FIG. 1 is a flowchart of a method for generating test cases according to an embodiment of the disclosure.

The method for generating test cases of the embodiment of the disclosure can be implemented by an apparatus for generating test cases of the embodiment of the disclosure. The apparatus may be configured in an electronic device to realize a function of generating test cases.

The electronic device may be any device having computing capability, such as a personal computer, a mobile terminal, a server, etc. The mobile terminal may be, for example, a vehicle-mounted device, a cellular phone, a tablet computer, a personal digital assistant, a wearable device, and other hardware devices with various operating systems, touchscreens and/or displays.

As illustrated in FIG. 1, the method for generating test cases includes the following steps.

At step 101, an original statement of work (SOW) of a target project and product information of a software product to be tested associated with the target project are obtained.

The SOW is a necessary material for running a project, which is a narrative description of a product or service to be provided by the project.

In the disclosure, a tester can access the original SOW of the target project after uploading the original SOW of the target project to a system, or directly read the original SOW of the target project locally.

The target project may involve one or more software products. The original SOW may contain a narrative description of one or more software products to be provided by the target project. The original SOW may specifically include what effects to be achieved, what software products or modules are included, metrics for each software product, and functions after implementation.

In the disclosure, the software product to be tested associated with the target project is determined based on the original SOW, and the product information of the software product to be tested is obtained from the original SOW.

Alternatively, the tester can upload project information of the target project (e.g., project name, project identity, etc.) while uploading the original SOW of the target project. Therefore, the project information of the target project is obtained, and the product information of the software product to be tested associated with the target project is obtained by querying based on the project information of the target project. Based on the project information of the target project, the product information of the software product to be tested can be obtained, which enriches the way of obtaining product information.

In the disclosure, the software product to be tested associated with the target project may refer to a software product included in the target project. The product information of the software product to be tested may include a product name, a product identity, and the like.

At step 102, product documentation and target historical test cases of the software product to be tested are obtained according to the product information.

The product documentation may include a requirement background of the product, an implementation mode of requirements, a corresponding interface interaction, etc. The target historical test cases may refer to test cases used in previous tests of the software product to be tested. There are one or more target test cases. The target historical test cases may be test cases that are manually written or automatically generated, which is not limited herein.

In the disclosure, the product documentation and the target historical test cases of the software product to be tested are obtained by retrieving from a product data base according to the product information.

The product data base may include product documentation, historical test cases, interface documentation, and the like of various products developed in the past.

The target historical test cases may be part or all of the historical test cases of the software product to be tested, which is not limited herein.

The test cases may be classified into various types such as process, function, interface, security, compatibility, ease of use, performance, stress, and so on. Optionally, all the historical test cases of the software product to be tested can be obtained from the product information of the software product to be tested, and a desired type of historical test case can be selected from all the historical test cases as the target historical test cases.

At step 103, the original SOW is segmented, and a plurality of segmented SOWs are obtained.

Since the length of the SOW may be large, in the disclosure, the original SOW may be segmented in accordance with a preset rule to obtain a plurality of segmented SOWs. For example, the original SOW may be segmented according to a number of characters required for a segment or according to the titles contained in the original SOW.

In addition, the SOW may contain a plurality of requirements, and by segmenting the original SOW, the requirements contained in the project can be split. In this case, each segmented SOW may contain one or more requirements.

In order to facilitate the description of product requirements, the SOW may contain some prototype images. In the disclosure, if the original SOW contains an image, the image may be converted into a textual description to obtain a new SOW. The new SOW may be further segmented to obtain a plurality of segmented SOWs. The original SOW is subjected to modal normalization, and the SOW after modal normalization can be used to generate test cases, which increases the accuracy of test cases.

To convert an image to a textual description, as a possible implementation, a question text corresponding to the image may be obtained, and feature extraction is performed on the image and the question text respectively to obtain image features of the image and textual features of the question text. The image features and the textual features are fused to obtain fusion features, and the fusion features are decoded to obtain an answer text of the question text. According to the answer text, a textual description corresponding to the image is obtained. As a result, when the image is used to answer the question in the question text, the image is converted into a description of the question, so as to realize the modal normalization of the SOW. The SOW after modal normalization can be used subsequently for generating test cases, to improve the accuracy of generating test cases.

The question in the question text may be a question based on the image, and there may be one or more questions in the question text. The answer text includes one or more answers to the one or more questions in the question text.

Optionally, the answers in the answer text may be fused to obtain a textual description corresponding to the image. For example, if there are a plurality of questions, the answers to the plurality of questions may be spliced into a coherent text, and thus a textual description is obtained. Or, the answers to the plurality of questions may be de-duplicated and combined to obtain a textual description.

Optionally, a context attention mechanism may be used to fuse the image features and the textual features to obtain a first feature, and then a spatial attention mechanism may be used to process the first feature to obtain a second feature. The second feature is fused with the textual features to obtain fusion features. As a result, by using the context attention mechanism and the spatial attention mechanism, the image features and the textual features are fused for a plurality of times, which improves the accuracy of the fusion features, thereby improving the accuracy of the textual description.

For ease of understanding, the following is illustrated in combination with FIG. 2. FIG. 2 is a schematic diagram of a process of converting an image into a textual description according to an embodiment of the disclosure. In FIG. 2, feature extraction is performed on a question image to obtain image features. The feature extraction is performed on a question text to obtain textual features. The context attention mechanism is used to fuse the image features and the textual features to obtain a first feature, which is further processed using the spatial attention mechanism to obtain a second feature. The second feature is fused with the textual features to obtain fusion features, the fusion features are decoded to obtain answers to the questions in the question text. After the above processes, the image is converted into a textual description.

The questions in the question text are obtained by questioning the question image.

As another possible implementation, the image can be converted into a textual description using a large model.

When segmenting the new SOW, as a possible implementation, the new SOW is segmented to obtain a plurality of segmented SOWs in accordance with a preset number of characters. The number of characters of each segmented SOW is less than or equal to the preset number of characters. That is, it is possible to segment the new SOW in accordance with the preset number of characters to obtain a plurality of segmented SOWs.

For example, if the preset number of characters is 1000, starting from a beginning of the new SOW, the new SOW is segmented every 1000 characters into the plurality of segmented SOWs.

It should be noted that the preset number of characters can be determined according to actual needs, which is not limited herein.

As another possible implementation, a text outline of the new SOW is extracted, and the new SOW is segmented into a plurality of segmented SOWs according to titles in the text outline. For example, text contents of two adjacent titles may be used as one segmented SOW.

As a result, the new SOW can be segmented in a variety of ways, and thus segmenting is flexible.

It should be noted that if the original SOW contains images, the images can be converted to textual descriptions before segmenting, or the original SOW may be segmented first and then images contained in segmented SOWs are converted to textual descriptions. For example, the text outline in the original SOW is extracted, and the original SOW is segmented according to the titles in the text outline to obtain the plurality of segmented SOWs. For the segmented SOWs that contain images, the images are converted to textual descriptions.

At step 104, target test cases of the software product to be tested is generated according to the plurality of segmented SOWs, the product documentation and the target historical test cases.

In the disclosure, the target historical test cases can be used as a reference to generate test cases corresponding to each segmented SOW based on each segmented SOW and the product documentation. According to the test cases of the plurality of segmented SOWs, the target test case of the software product to be tested under a delivery scenario of the target project can be obtained.

If the target project contains a plurality of software products, the segmented SOWs, the product documentation, and the target historical test cases corresponding to each software product to be tested can be determined. The target test cases of each software product to be tested are generated according to the corresponding segmented SOWs, the product documentation and the target historical test cases of each software product to be tested. The segmented SOWs corresponding to the software product to be tested is understood as segmented SOWs describing the software product to be tested.

Optionally, interface documentation of the software product to be tested is obtained by retrieving according to the product information of the software product to be tested. According to the segmented SOWs, the product documentation, the interface documentation and the target historical test cases, the target test cases of the software product to be tested may be obtained in a unit testing phase.

As can be seen, the method for generating test cases in the embodiments of the disclosure can be applied for generating test cases in a plurality of software testing phases.

In embodiments of the disclosure, the product documentation and the target historical test cases of the software product to be tested can be obtained according to the product information of the software product to be tested. The target test cases are generated according to the original SOW in combination with the product documentation and the target historical test cases, which makes the generated test cases closer to the product requirements and improves the accuracy of the test cases. The original SOW is segmented into a plurality of segmented SOWs, which are used to generate test cases, to improve the efficiency of generating test cases.

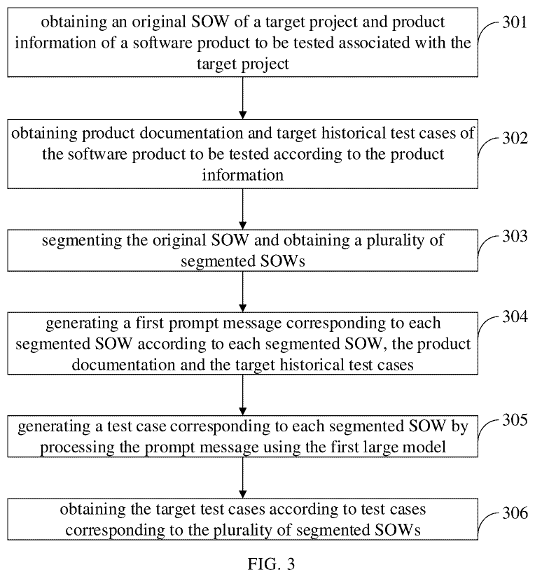

FIG. 3 is a flowchart of a method for generating test cases according to an embodiment of the disclosure.

As illustrated in FIG. 3, the method for generating test cases includes the following steps.

At step 301, an original SOW of a target project and product information of a software product to be tested associated with the target project are obtained.

In the disclosure, step 301 may be implemented in any one of the implementations of the embodiments of the disclosure, which will not be repeated herein.

At step 302, product documentation and target historical test cases of the software product to be tested are obtained according to the product information.

In the disclosure, step 302 may be implemented in any one of the implementations of the embodiments of the disclosure, which will not be repeated herein.

At step 303, the original SOW is segmented, and a plurality of segmented SOWs are obtained.

In the disclosure, step 303 may be implemented in any one of the implementations of the embodiments of the disclosure, which will not be repeated herein.

At step 304, a first prompt message corresponding to each segmented SOW is generated according to each segmented SOW, the product documentation and the target historical test cases.

The first prompt message is used to instruct a first large model to perform a test case generation task. The first prompt message may include a segmented SOW, the product documentation, the target historical test cases, and test case generation task information, etc.

The test case generation task information may include output requirement information of the first large model. The output requirement information may include a requirement on a number of test cases output by the first large model. For example, the test case generation task information is “generating 10 test cases”.

For example, the first prompt message is “generating 5 test cases by with reference to the target historical test cases and in combination with information of requirements to be implemented as described in the segmented SOW and the product documentation”.

At step 305, one or more test cases corresponding to each segmented SOW are generated by processing the first prompt message using the first large model.

In the disclosure, the first prompt message may be input into the first large model for processing to obtain test cases output by the first large model, and the test cases output by the first large model may be used as the test cases corresponding to each segmented SOW. Or, one or more test cases may be filtered from the test cases output by the first large model as the test cases corresponding to the segmented SOW.

For example, for a segmented SOW, quality evaluation is performed on the test cases output by the first large model, and the test cases whose evaluation results satisfy a requirement are used as the test cases corresponding to the segmented SOW.

At step 306, the target test cases are obtained according to test cases corresponding to the plurality of segmented SOWs.

In the disclosure, the test cases corresponding to the plurality of segmented SOWs may be used as the target test cases of the software product to be tested.

If the target project contains a plurality of software products, test cases corresponding to segmented SOWs for each software product to be tested may be used as the target test cases of each software product to be tested.

In the embodiments of the disclosure, the original SOW is segmented, and the requirements in the SOW may be split. When the target test cases are generated based on segmented SOWs, and thus test cases for different requirements are obtained, which improves the efficiency of generating test cases.

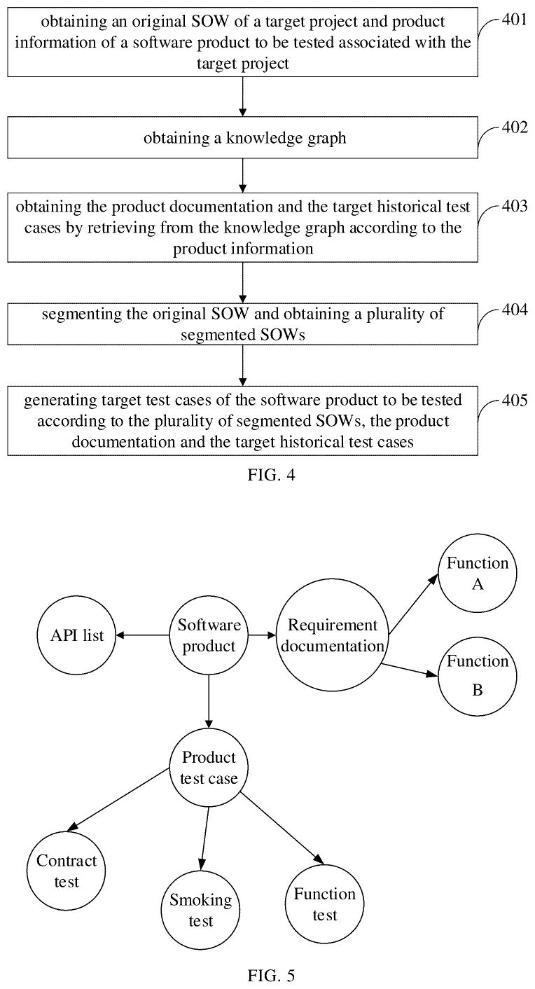

FIG. 4 is a flowchart of a method for generating test cases according to an embodiment of the disclosure.

As illustrated in FIG. 4, the method for generating test cases includes the following steps.

At step 401, an original SOW of a target project and product information of a software product to be tested associated with the target project are obtained.

In the disclosure, step 401 may be implemented in any one of the implementations of the embodiments of the disclosure, which will not be repeated herein.

At step 402, a knowledge graph is obtained.

The knowledge graph may include relations among software products, a product documentation, and historical test cases. The knowledge graph can be stored using a graph database, which uses a graph structure to represent an association between an entity and a relation, to facilitate efficient queries.

In the disclosure, the knowledge graph may be created based on product documentation, historical test cases, interface documentation, etc., of a plurality of software products. FIG. 5 shows an exemplary diagram of a knowledge graph according to an embodiment of the disclosure.

For example, the knowledge graph may be created through processes such as knowledge entry, knowledge disambiguation, knowledge fusion, and the like.

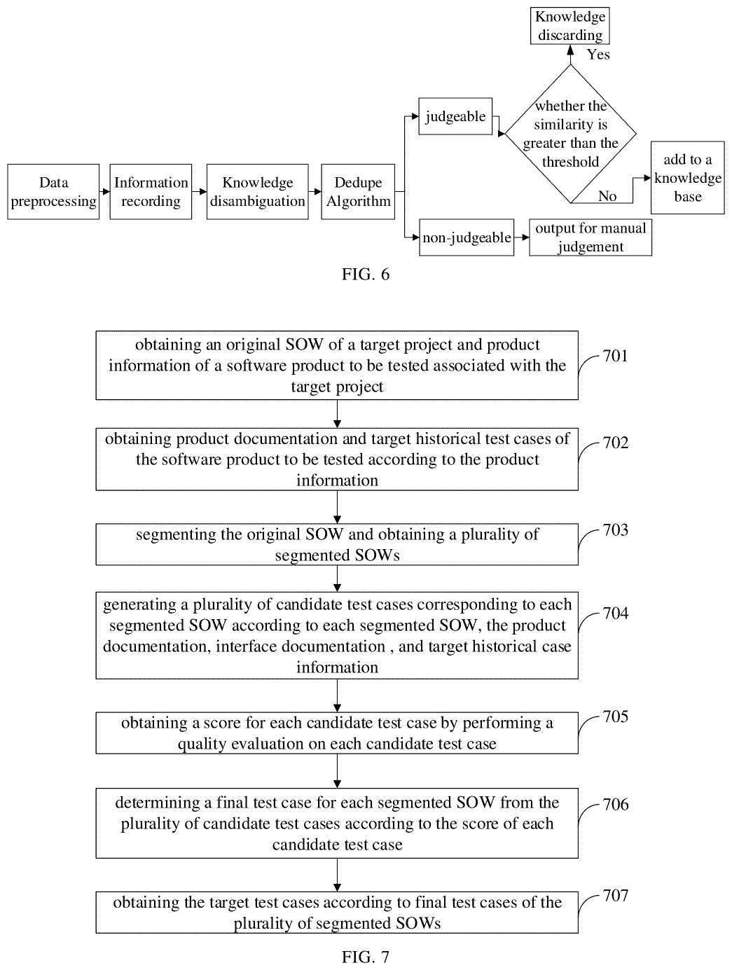

In the process of the knowledge fusion, it mainly focuses on quality of knowledge and a repetition of knowledge contents, and the main process can be seen in FIG. 6. In FIG. 6, data preprocessing can refer to preprocessing information to be added to the knowledge graph. Information recording refers to localized storing the processed data. Then the knowledge disambiguation is performed, and a similarity between newly added knowledge and existing knowledge in a knowledge base is calculated using dedupe algorithm, and then disambiguation is carried out based on the similarity. If the similarity is greater than a threshold, the newly added knowledge may be discarded, otherwise the newly added knowledge is added to the knowledge base. The dedupe algorithm is an active learning algorithm, and if the similarity cannot be calculated by using the dedupe algorithm, the newly added knowledge may be output to a system log and then handed over to the relevant personnel for manual judgment in a form of a timed task.

The dedupe algorithm uses cosine similarity to perform a similarity measurement of string attribute values, for two objects to be matched, i.e., x and y, which both have the same number of attribute values (e.g., n, n being a positive integer), the calculation is performed by the cosine similarity through the following equation:

$$sim ( x , y ) = \frac{vec ( {P}_{x} ) vec ( {P}_{y} )}{\vert {P}_{x} \vert \vert {P}_{y} \vert}$$

where, Pₓ represents an attribute value of x, P_{y} represents an attribute value of y, vec(Pₓ) and vec(P_{y}) represent vectors.

The knowledge base may include information such as entities, entity attributes, etc. in the knowledge graph.

At step 403, the product documentation and the target historical test cases are obtained by retrieving from the knowledge graph according to the product information.

In the disclosure, if the target project contains a plurality of software products, for each software product to be tested, product documentation and target historical test cases corresponding to each software product to be tested can be obtained by retrieving from the knowledge graph based on the product information of each software product to be tested.

In an example, assuming that there are 20 software products that have been developed and the knowledge graph is created based on these 20 software products, if a certain project is to improve 3 of them according to customer requirements to make the improved software products meet the customer requirements, it can be seen that the project involves 3 software products. By retrieving from the knowledge graph, product documentation and target historical test cases for each of the 3 software products are obtained.

Optionally, the product information of the software product to be tested is matched with nodes in the knowledge graph, to determine a node matching the product information, which represents the software product to be tested. From nodes connected to the node corresponding to the software product to be tested, nodes representing the product documentation and nodes representing the historical test cases are queried to obtain the product documentation and the historical test cases, and then the target historical test cases are determined from the historical test cases.

In order to improve the accuracy of retrieval result, a first keyword is extracted from the original SOW, and the product documentation and the target historical test cases of the software product to be tested are obtained by retrieving from the knowledge graph according to the product information of the software product to be tested and the first keyword. As a result, retrieving can be carried out based on the product information in combination with the keyword in the SOW, which can improve the accuracy of the retrieval result.

Optionally, keyword extraction may be performed on the original SOW using the large model to obtain the first keyword, or the original SOW can be tokenized to obtain a plurality of tokens, and word frequency-inverse file frequency of each word can be determined, and then the first keyword can be determined from the plurality of tokens based on term frequency-inverse document frequency (TF-IDF) of each token. For example, a plurality of tokens with the highest TF-IDF are taken as the first keyword.

Optionally, if the original SOW does not contain an image, the first keyword may be extracted directly from the original SOW. If the original SOW contains an image, the first keyword may be extracted after converting the image to a textual description. Therefore, the accuracy of the extracted first keyword can be improved.

Optionally, the product information of the software product to be tested may be matched with the nodes in the knowledge graph to determine a first node that matches the product information. Based on a first relation between the software product and the product documentation, a second node whose relation with the first node is a first relation is determined from the knowledge graph. According to a second relation between the software product and a test case, a third node whose relation with the first node is the second relation is determined from the knowledge graph. The first keyword is matched with a second keyword of each historical test case, and a keyword matching result between the first keyword and the second keyword of each historical test case is obtained. According to the keyword matching result corresponding to each historical test case, the target historical test cases are determined from the historical test cases.

As a result, based on matching results of the product information with the nodes in the knowledge graph, the relations among the software product, the product documentation and the test cases, are matched with the relations between the software product to be tested and other nodes, and based on relation matching results, the product documentation and the historical test cases are obtained. According to the matching results of keywords in the SOW with keywords of the historical test cases, the target historical test cases are determined, which improves the accuracy of retrieval results of the knowledge graph.

The first node represents the software product to be tested. The second node represents product documentation of the software product to be tested. The third node represents a historical test case of the software product to be tested.

The first relation may be used to indicate product documentation corresponding to the software product, and the second relation may be used to indicate a test case corresponding to the software product.

For example, the first relation may be matched with the relations between the first node and other nodes, if the relation between the first node and a certain node is consistent with the first relation, the node is the second node, and the product documentation of the software product to be tested is thus retrieved.

For example, the second relation may be matched with the relations between the first node and other nodes, if the relation between the first node and a certain node is consistent with the second relation, the node is the third node, and the historical test cases of the software product to be tested are thus retrieved.

Optionally, the historical test cases whose second keywords match the first keyword are determined as the target historical test cases.

Optionally, type labels of the test cases may include process, function, interface, security, compatibility, ease of use, performance, stress, etc. The knowledge graph may include the type labels of each historical test case, and the historical test cases whose keyword matching results are matching and whose type labels are a preset label are determined as the target historical test cases.

For example, common types of test cases in a project delivery scenario include function, interface, security, stress, etc. According to the keyword matching results and the type labels, the target historical test cases whose types are function, interface, security, and stress and the like can be selected from the historical test cases.

As a result, based on the matching results of the keywords of the SOW with the keywords of the historical test cases and the type labels of the historical test cases, the required type of historical test cases can be filtered from the historical test cases, which meets diversified test requirements.

At step 404, the original SOW is segmented, and a plurality of segmented SOWs are obtained.

In the disclosure, step 403 may be implemented in any one of the implementations of the embodiments of the disclosure, which will not be repeated herein.

At step 405, target test cases of the software product to be tested are generated according to the plurality of segmented SOWs, the product documentation and the target historical test cases.

In the disclosure, step 405 may be implemented in any one of the implementations of the embodiments of the disclosure, which will not be repeated herein.

In the embodiments of the disclosure, the knowledge graph is obtained and the product documentation and the target historical test cases are obtained by retrieving from the knowledge graph based on the product information, which improves the efficiency and accuracy of obtaining the product documentation and the target historical test cases. The target test cases for the software product to be tested are generated according to the segmented SOWs in combination with the product documentation and the target historical test cases, which improves the accuracy of generating test cases.

FIG. 7 is a flowchart of a method for generating test case according to another embodiment of the disclosure.

As illustrated in FIG. 7, the method for generating test cases includes the following steps.

At step 701, an original SOW of a target project and product information of a software product to be tested associated with the target project are obtained.

In the disclosure, step 701 may be implemented in any one of the implementations of the embodiments of the disclosure, which will not be repeated herein.

At step 702, product documentation and target historical test cases of the software product to be tested are obtained according to the product information.

In the disclosure, step 702 may be implemented in any one of the implementations of the embodiments of the disclosure, which will not be repeated herein.

At step 703, the original SOW is segmented, and a plurality of segmented SOWs are obtained.

In the disclosure, step 703 may be implemented in any one of the implementations of the embodiments of the disclosure, which will not be repeated herein.

At step 704, a plurality of candidate test cases corresponding to each segmented SOW are generated according to each segmented SOW, product documentation, interface documentation, and target historical case information.

In the disclosure, first prompt message corresponding to each segmented SOW may be generated according to each segmented SOW, the product documentation, the interface documentation, and the target historical case information. The first prompt message is processed using a first large model to obtain the candidate test cases corresponding to each segmented SOW output by the first large model. Detailed explanations of the use of the first large model to obtain the candidate test cases herein can be referred to the descriptions in other embodiments, which will not be repeated herein.

At step 705, a score for each candidate test case is obtained by performing a quality evaluation on each candidate test case.

In the disclosure, for each segmented SOW, original requirement information corresponding to the candidate test cases is obtained. According to the original requirement information and the candidate test cases, a second prompt message is generated and then processed using a second large model to obtain scores of candidate test cases output by the second large model. As a result, the second large model performs quality evaluation on the generated candidate test cases, which improves the accuracy of evaluation results and evaluation efficiency.

The second prompt message may be used to prompt the second large model to perform the test case quality evaluation task.

The original requirement information may be obtained from the segmented SOWs, from the product documentation, or by other means, which is not limited herein.

The greater the score of the candidate test case, the higher the correlation between the candidate test case and the original requirement information, which means that it is easier to use this candidate test case for testing to determine whether the software product to be tested has realized the original requirement information.

For example, if there are 5 candidate test cases corresponding to a segmented SOW, and the 5 test cases and original requirement information corresponding to the 5 test cases are input into the second large model for quality evaluation, and the second large model outputs scores of the 5 candidate test cases. The scores are greater than or equal to 0 and less than or equal to 1.

Optionally, reference requirement information and reference test cases of the software product to be tested may be obtained. An original large model is fine-tuned using the reference requirement information and the reference test cases to obtain the second large model. As a result, the second large model obtained by fine-tuning is used to perform quality evaluation on the generated test cases, which improves the accuracy of evaluation.

Optionally, a knowledge graph may be obtained, which includes relations among software products, product documentation and historical test cases. According to the product information, historical test cases of the software product to be tested are obtained from the knowledge graph, and the detailed process of which may be referred to the above embodiments. According to a generation mode label of the historical test case, the reference test cases is determined from the historical test cases, and the requirement information corresponding to the reference test cases is determined as the reference requirement information.

The generation mode label of the historical test case is used to indicate a generation mode of the historical test case. The historical test cases may be generated manually or automatically, and thus the generation mode label of the historical test case may be manual or automatic, etc.

In order to improve the accuracy of the generated test cases, for example, historical test cases whose generation mode labels are manual are determined as reference test cases, and the requirement information corresponding to the reference test cases is the reference requirement information.

As a result, the historical test cases of the software product to be tested can be obtained from the knowledge graph, and then required reference test cases and corresponding reference requirement information can be filtered out according to the generation mode label, so that a required large model can be obtained by fine-tuning.

At step 706, one or more final test case for each segmented SOW is determined from the plurality of candidate test cases according to the score of each candidate test case.

In the disclosure, for the candidate test cases of each segmented SOW, a candidate test case whose score is greater than a preset threshold is determined as a final test case for the segmented SOW.

For example, for 5 candidate test cases of a segmented SOW, if there are 3 candidate test cases whose scores are greater than a preset threshold of 0.6, the 3 candidate test cases may be determined as the final test cases for the segmented SOW.

It should be noted that the preset threshold may be determined according to actual needs, which is not limited herein.

At step 707, the target test case is obtained according to final test cases of the plurality of segmented SOWs.

In the disclosure, the final test cases of the plurality of segmented SOWs may be used as the target test cases of the software product to be tested.

In embodiments of the disclosure, quality evaluation is performed on the test cases generated for each segmented SOW, and the final test cases are filtered based on the scores for testing the software product to be tested, which improves the accuracy and efficiency of testing.

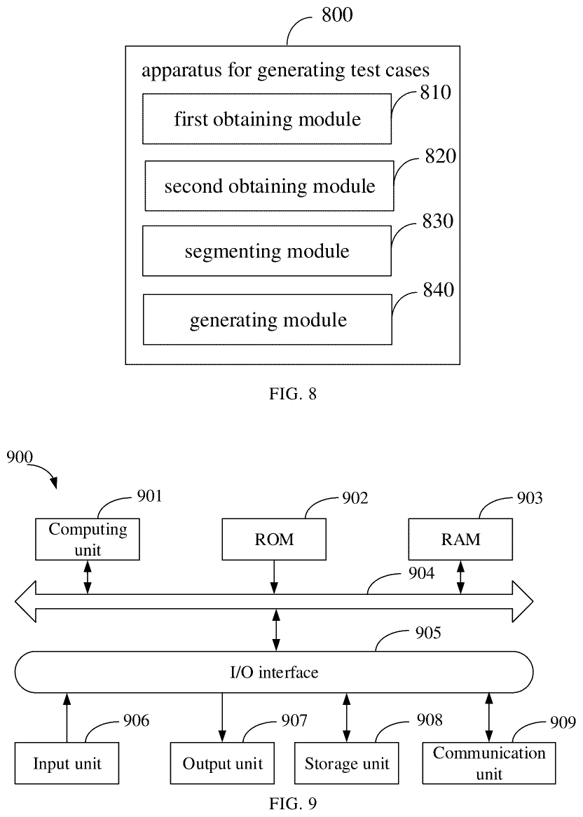

In order to realize the above embodiments, the embodiments of the disclosure also provide an apparatus for generating test cases. FIG. 8 is a block diagram of an apparatus 800 for generating test cases according to an embodiment of the disclosure.

As illustrated in FIG. 8, the apparatus 800 includes:
a first obtaining module 810, configured to obtain an original SOW of a target project and product information of a software product to be tested associated with the target project;
a second obtaining module 820, configured to obtain product documentation and target historical test cases of the software product to be tested according to the product information;
a segmenting module 830, configured to segment the original SOW and obtain a plurality of segmented SOWs; and
a generating module 840, configured to generate target test cases of the software product to be tested according to the plurality of segmented SOWs, the product documentation and the target historical test cases.

Optionally, the generating module 840 is configured to:
generate a first prompt message corresponding to each segmented SOW according to each segmented SOW, the product documentation and the target historical test cases, in which the first prompt message is used to instruct a first large model to perform a test case generation task;
generate one or more test cases corresponding to each segmented SOW by processing the prompt message using the first large model; and
obtain the target test cases according to test cases corresponding to the plurality of segmented SOWs.

Optionally, the second obtaining module 820 is configured to:
obtain a knowledge graph, in which the knowledge graph includes relations among software products, product documentation and historical test cases; and
obtain the product documentation and the target historical test cases by retrieving from the knowledge graph according to the product information.

Optionally, the second obtaining module 820 is configured to:
extract a first keyword from the original SOW; and
obtain the product documentation and the target historical test cases by retrieving from the knowledge graph according to the product information and the first keyword.

Optionally, the second obtaining module 820 is configured to:
match the product information with nodes in the knowledge graph to determine a first node that matches with the product information, in which the first node represents the software product to be tested;
determine, according to a first relation between the software product and product documentation, a second node whose relation with the first node is the first relation from the knowledge graph, in which the second node represents product documentation of the software product to be tested;
determine, according to a second relation between the software product and a test case, a third node whose relation with the first node is the second relation from the knowledge graph, in which the third node represents a historical test case of the software product to be tested;
match the first keyword with a second keyword of each historical test case to obtain a keyword match result between the first keyword and the second keyword of each historical test case; and
determine the target historical test cases from the historical test cases according to the keyword match result corresponding to each historical test case.

Optionally, the second obtaining module 820 is configured to:
obtain a type label of each historical test case from the knowledge graph; and
determine historical test cases whose keyword match results are matching and whose type labels are a preset label as the target historical test cases.

Optionally, the segmenting module 830 is configured to:
in response to the original SOW containing an image, convert the image into a textual description to obtain a new SOW; and
obtain the plurality of segmented SOWs by segmenting the new SOW.

Optionally, the segmenting module 830 is configured to:
obtain a question text corresponding to the image, in which a question in the question text is a question asked based on the image;
obtain an image feature by performing feature extraction on the image;
obtain a textual feature by performing feature extraction on the question text;
obtain a fusion feature by fusing the image feature and the textual feature;
obtain an answer text of the question text based on the fusion feature; and
obtain a textual description corresponding to the image according to the answer text.

Optionally, the segmenting module 830 is configured to:
segment the new SOW according to a preset number of characters and obtain the plurality of segmented SOWs, in which each of the segmented SOWs contains a number of characters less than or equal to the preset number of characters; and
extract a text outline of the new SOW, and obtain the plurality of segmented SOWs by segmenting the new SOW according to titles in the text outline.

Optionally, the generating module 840 is configured to:
generate a plurality of candidate test cases corresponding to each segmented SOW according to each segmented SOW, the product documentation, interface documentation, and target historical case information;
obtain a score for each candidate test case by performing a quality evaluation on each candidate test case;
determine one or more final test cases for each segmented SOW from the plurality of candidate test cases according to the score of each candidate test case; and
obtain the target test cases according to final test cases of the plurality of segmented SOWs.

Optionally, the generating module 840 is configured to:
obtain original requirement information corresponding to the plurality of candidate test cases;
generate a second prompt message according to the plurality of candidate test cases and the original requirement information, in which the second prompt message is used to instruct a second large model to perform a test case quality evaluation task; and
obtain the score for each candidate test case by processing the second prompt message using the second large model.

Optionally, the apparatus further includes:
a third obtaining module, configured to obtain reference requirement information and reference test cases of the software product to be tested; and
a fine-tuning module, configured to obtain the second large model by fine-tuning an original large model using the reference requirement information and the reference test cases.

Optionally, the third obtaining module is configured to:
obtain a knowledge graph, in which the knowledge graph includes relations among software products, product documentation and historical test cases;
obtain a plurality of historical test cases of the software product to be tested from the knowledge graph according to the product information; and
determine the reference test cases from the plurality of historical test cases according to a generation mode label of each historical test case, and determine requirement information corresponding to the reference test cases as the reference requirement information.

Optionally, the first obtaining module 810 is configured to:
obtain project information of the target project; and
obtain the product information according to the project information.

It should be noted that the foregoing illustrations of the method for generating test cases of the method embodiments are also applicable to an apparatus for generating test cases of the embodiment, which will not be repeated herein.

In embodiments of the disclosure, the product documentation and the target historical test cases of the software product to be tested are obtained according to the product information of the software product to be tested. The target test cases are generated based on the original SOW in combination with the product documentation and the target historical test cases, which makes the generated test cases closer to the product requirements and improves the accuracy of the test cases. The original SOW is segmented into a plurality of segmented SOWs, and test cases are generated using the segmented SOWs, which improves the efficiency of generating test cases.

According to the embodiments of the disclosure, the disclosure also provides an electronic device, a readable storage medium, and a computer program product.

FIG. 9 is a block diagram of an electronic device 900 for implementing the embodiments of the disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile devices, such as personal digital processors, cellular phones, smart phones, wearable devices, and other similar computing devices. The components shown here, their connections and relations, and their functions are merely examples, and are not intended to limit the implementations of the disclosure described and/or required herein.

As illustrated in FIG. 9, the device 900 includes a computing unit 901 for performing various appropriate actions and processes based on computer programs stored in a Read-Only Memory (ROM) 902 or computer programs loaded from a storage unit 908 to a Random Access Memory (RAM) 903. In the RAM 903, various programs and data required for the operation of the device 900 are stored. The computing unit 901, the ROM 902, and the RAM 903 are connected to each other through a bus 904. An input/output (I/O) interface 905 is also connected to the bus 904.

Components in the device 900 are connected to the I/O interface 905, including: an input unit 906, such as a keyboard, a mouse; an output unit 907, such as various types of displays, speakers; the storage unit 908, such as a disk, an optical disk; and a communication unit 909, such as network cards, modems, and wireless communication transceivers. The communication unit 909 allows the device 900 to exchange information/data with other devices through a computer network such as the Internet and/or various telecommunication networks.

The computing unit 901 may be various general-purpose and/or dedicated processing components with processing and computing capabilities. Some examples of the computing unit 901 include, but are not limited to, a Central Processing Unit (CPU), a Graphics Processing Unit (GPU), various dedicated AI computing chips, various computing units that run machine learning model algorithms, and a Digital Signal Processor (DSP), and any appropriate processor, controller and microcontroller. The computing unit 901 executes the various methods and processes described above, such as the method for generating test cases. For example, in some embodiments, the method for generating test cases may be implemented as computer software programs, which are tangibly included in a machine-readable medium, such as the storage unit 908. In some embodiments, part or all of the computer programs may be loaded and/or installed on the device 900 via the ROM 902 and/or the communication unit 909. When the computer programs are loaded on the RAM 903 and executed by the computing unit 901, one or more steps of the method described above may be executed. Alternatively, in other embodiments, the computing unit 901 may be configured to perform the method for generating test cases in any other suitable manner (for example, by means of firmware).

Various implementations of the systems and techniques described above may be implemented by a digital electronic circuit system, an integrated circuit system, a Field Programmable Gate Array (FPGA), an Application-Specific Integrated Circuits (ASIC), an Application Specific Standard Products (ASSP), a System on Chip (SOC), a Complex programmable logic device (CPLD), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

Program codes configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program codes may be executed entirely on the machine, partly executed on the machine, partly executed on the machine and partly executed on a remote machine as an independent software package, or entirely executed on the remote machine or a server.

In the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMS, ROMs, Electrically Programmable ROMs (EPROMs), flash memories, fiber optics, Compact Disc ROMs (CD-ROMs), optical storage devices, magnetic storage devices, or any suitable combination of the foregoing.

In order to provide interaction with a user, the systems and techniques described herein may be implemented on a computer having a display device (e.g., a Cathode-Ray Tube (CRT) or a Liquid Crystal Display (LCD) monitor) for displaying information to a user; and a keyboard and a pointing device (such as a mouse or trackball) through which the user may provide input to the computer. Other kinds of devices may also be used to provide interaction with the user. For example, feedback provided to the user may be any form of sensory feedback (e.g., visual feedback, auditory feedback, or tactile feedback), and input from the user may be received in any form (including acoustic input, speech input, or tactile input).

The systems and technologies described herein can be implemented in a computing system that includes backend components (for example, a data server), or a computing system that includes middleware components (for example, an application server), or a computing system that includes front-end components (for example, a user computer with a graphical user interface or a web browser, through which the user can interact with the implementation of the systems and technologies described herein), or a computing system that includes any combination of such backend components, middleware components, and front-end components. The components of the system may be interconnected by any form or medium of digital data communication (e.g., a communication network). Examples of communication networks include: a Local Area Network (LAN), a Wide Area Network (WAN), Internet, and a blockchain network.

The computer system may include a client and a server. The client and server are generally remote from each other and interacting through a communication network. The client-server relation is generated by computer programs running on respective computers and having a client-server relation with each other. The server may be a cloud server, also known as a cloud computing server or a cloud host, which is a host product in a cloud computing service system to solve difficult management and poor service expansion of traditional physical hosting and Virtual Private Server (VPS) services. The server may be a server of a distributed system, or a server combined with a blockchain.

According to embodiments of the disclosure, the disclosure also provides a computer program product having instructions stored thereon. When the instructions are executed by a processor, the above method for generating test cases of the embodiments of the disclosure is implemented.

It should be understood that various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific implementations do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

1. A method for generating test cases, comprising:
obtaining an original statement of work (SOW) of a target project and product information of a software product to be tested associated with the target project;
obtaining product documentation and target historical test cases of the software product to be tested according to the product information;
segmenting the original SOW and obtaining a plurality of segmented SOWs; and
generating target test cases of the software product to be tested according to the plurality of segmented SOWs, the product documentation and the target historical test cases.

2. The method of claim 1, wherein generating the target test cases of the software product to be tested according to the plurality of segmented SOWs, the product documentation and the target historical test cases, comprises:
generating a first prompt message corresponding to each segmented SOW according to each segmented SOW, the product documentation and the target historical test cases, wherein the first prompt message is used to instruct a first large model to perform a test case generation task;
generating a test case corresponding to each segmented SOW by processing the first prompt message using the first large model; and
obtaining the target test cases according to test cases corresponding to the plurality of segmented SOWs.

3. The method of claim 1, wherein obtaining the product documentation and the target historical test cases of the software product to be tested according to the product information, comprises:
obtaining a knowledge graph, wherein the knowledge graph comprises relations among software products, product documentation and historical test cases; and
obtaining the product documentation and the target historical test cases by retrieving from the knowledge graph according to the product information.

4. The method of claim 3, wherein obtaining the product documentation and the target historical test cases by retrieving from the knowledge graph according to the product information, comprises:
extracting a first keyword from the original SOW; and
obtaining the product documentation and the target historical test cases by retrieving from the knowledge graph according to the product information and the first keyword.

5. The method of claim 4, wherein obtaining the product documentation and the target historical test cases by retrieving from the knowledge graph according to the product information and the first keyword, comprises:
matching the product information with nodes in the knowledge graph to determine a first node that matches with the product information, wherein the first node represents the software product to be tested;
determining, according to a first relation between the software product and the product documentation, a second node whose relation with the first node is the first relation from the knowledge graph, wherein the second node represents product documentation of the software product to be tested;
determining, according to a second relation between the software product and a test case, a third node whose relation with the first node is the second relation from the knowledge graph, wherein the third node represents a historical test case of the software product to be tested;
matching the first keyword with a second keyword of each historical test case to obtain a keyword match result between the first keyword and the second keyword of each historical test case; and
determining the target historical test cases from the historical test cases according to the keyword match result corresponding to each historical test case.

6. The method of claim 5, wherein determining the target historical test cases from the historical test cases according to the keyword match result corresponding to each historical test case, comprises:
obtaining a type label of each historical test case from the knowledge graph; and
determining historical test cases whose keyword match results are matching and whose type labels are a preset label as the target historical test cases.

7. The method of claim 1, wherein segmenting the original SOW and obtaining the plurality of segmented SOWs, comprise:
in response to the original SOW containing an image, converting the image into a text description to obtain a new SOW; and
obtaining the plurality of segmented SOWs by segmenting the new SOW.

8. The method of claim 7, wherein converting the image into the text description, comprises:
obtaining a question text corresponding to the image, wherein a question in the question text is a question asked based on the image;
obtaining an image feature by performing feature extraction on the image;
obtaining a textual feature by performing feature extraction on the question text;
obtaining a fusion feature by fusing the image feature and the textual feature;
obtaining an answer text of the question text based on the fusion feature; and
obtaining the text description corresponding to the image according to the answer text.

9. The method of claim 7, wherein obtaining the plurality of segmented SOWs by segmenting the new SOW, comprise one or more of the following:
segmenting the new SOW according to a preset number of characters and obtaining the plurality of segmented SOWs, wherein each of the segmented SOWs contains a number of characters less than or equal to the preset number of characters; and
extracting a text outline of the new SOW, and obtaining the plurality of segmented SOWs by segmenting the new SOW according to titles in the text outline.

10. The method of claim 1, wherein generating the target test cases of the software product to be tested according to the plurality of segmented SOWs, the product documentation and the target historical test cases, comprises:
generating a plurality of candidate test cases corresponding to each segmented SOW according to each segmented SOW, the product documentation, interface documentation, and target historical case information;
obtaining a score for each candidate test case by performing a quality evaluation on each candidate test case;
determining a final test case for each segmented SOW from the plurality of candidate test cases according to the score of each candidate test case; and
obtaining the target test cases according to final test cases of the plurality of segmented SOWs.

11. The method of claim 10, wherein obtaining the score for each candidate test case by performing the quality evaluation each candidate test case comprises:
obtaining original requirement information corresponding to the plurality of candidate test cases;
generating a second prompt message according to the plurality of candidate test cases and the original requirement information, wherein the second prompt message is used to instruct a second large model to perform a test case quality evaluation task; and
obtain the score for each candidate test case by processing the second prompt message using the second large model.

12. The method of claim 11, further comprising:
obtaining reference requirement information and reference test cases of the software product to be tested; and
obtaining the second large model by fine-tuning an original large model using the reference requirement information and the reference test cases.

13. The method of claim 12, wherein obtaining the reference requirement information and the reference test cases of the software product to be tested, comprises:
obtaining a knowledge graph, wherein the knowledge graph comprises relations among software products, product documentation and historical test cases;
obtaining a plurality of historical test cases of the software product to be tested from the knowledge graph according to the product information; and
determining the reference test cases from the plurality of historical test cases according to a generation mode label of each historical test case, and determining requirement information corresponding to the reference test cases as the reference requirement information.

14. (canceled)

15. An electronic device comprising:
at least one processor; and
a memory communicatively connected to the at least one processor;
wherein the memory stores instructions executable by the at least one processor, and the at least one processor is configured to:
obtain an original statement of work (SOW) of a target project and product information of a software product to be tested associated with the target project;
obtain product documentation of the software product to be tested and target historical test cases according to the product information;
segment the original SOW and obtain a plurality of segmented SOWs; and
generate target test cases of the software product to be tested according to the plurality of segmented SOWs, the product documentation and the target historical test cases.

16. The electronic device of claim 15, wherein the at least one processor is configured to:
generate a first prompt message corresponding to each segmented SOW according to each segmented SOW, the product documentation and the target historical test cases, wherein the first prompt message is used to indicate a first large model to perform a test case generation task;
process the prompt message using the first large model to generate a test case corresponding to each segmented SOW; and
obtain the target test cases according to test cases corresponding to the plurality of segmented SOWs.

17. The electronic device of claim 15, wherein the at least one processor is configured to:
obtain a knowledge graph, wherein the knowledge graph comprises relations among software products, product documentation and historical test cases; and
obtain the product documentation and the target historical test cases by retrieving from the knowledge graph according to the product information.

18. The electronic device of claim 17, wherein the at least one processor is configured to:
extract a first keyword from the original SOW; and
obtain the product documentation and the target historical test cases by retrieving from the knowledge graph according to the product information and the first keyword.

19. The electronic device of claim 18, wherein the at least one processor is configured to:
match the product information with nodes in the knowledge graph to determine a first node that matches with the product information, wherein the first node represents the software product to be tested;
determine, according to a first relation between the software product and the product documentation, a second node whose relation with the first node is the first relation from the knowledge graph, wherein the second node represents a product documentation of the software product to be tested;
determine, according to a second relation between the software product and a test case, a third node whose relation with the first node is the second relation from the knowledge graph, wherein the third node represents a historical test case of the software product to be tested;
match the first keyword with a second keyword of each historical test case to obtain a keyword match result between the first keyword and the second keyword of each historical test case; and
determine the target historical test cases from the historical test cases according to the keyword match result corresponding to each historical test case.

20. The electronic device of claim 19, wherein the at least one processor is configured to:
obtain a type label of each historical test case from the knowledge graph; and
determine historical test cases whose keyword match results are matching and whose type labels are a preset label as the target historical test cases.

21. The electronic device of claim 15, wherein the at least one processor is configured to:
generate a plurality of candidate test cases corresponding to each segmented SOW according to each segmented SOW, the product documentation, an interface documentation, and target historical case information;
obtain a score for each candidate test case by performing a quality evaluation on each candidate test case;
determine a final test case for each segmented SOW from the plurality of candidate test cases according to the score of each candidate test case; and
obtain the target test cases according to final test cases of the plurality of segmented SOWs.

22.-31. (canceled)
